(19) United States
(12) Patent Application Publication
(10) Pub. No.: US 2025/0028767 A1
(43) Pub. Date: Jan. 23, 2025

(54) SYSTEM AND METHODS FOR RETRIEVING AND GENERATING RECOMMENDATIONS OF MULTI-MODAL DOCUMENTS

(71) Applicant: JIO PLATFORMS LIMITED, Ahmedabad (IN)

(72) Inventors: Juhi TANDON, Kolkata (IN); Mohit SHARMA, Panchkula (IN); Amit SACHAN, Bangalore (IN)

(73) Assignee: JIO PLATFORMS LIMITED, Ahmedabad (IN)

(21) Appl. No.: 18/714,311

(22) PCT Filed: Nov. 28, 2022
(86) PCT No.: PCT/IB2022/061476

§ 371 Date: May 29, 2024

(30) Foreign Application Priority Data
Nov. 29, 2021 (IN) 202121055230

(51) Int. Cl. G06F 16/9535; G06F 40/284; G06V 10/74

(52) U.S. Cl. CPC G06F 16/9535; G06F 40/284; G06V 10/761

(57) ABSTRACT

The present disclosure relates to information retrieval in computing systems in general and in particular to retrieving articles from various publishers corresponding to the breaking news headline. The present invention provides solution to the above-mentioned problem in the art by providing a system and a method for efficiently presenting a more accurate method of providing the relevant articles in a breaking news system to add value in terms of more user engagement and satisfaction. The system can use semantic models and multilingually trained sentence transformers to generate context-based recommendations for a breaking news headline. It is further refined by use of Knowledge Graphs (KG) and additional modes of information like images, videos present in the news article. These language agnostic signals along with the semantic understanding enables to generate succinct cross lingual recommendations.

### FIELD OF INVENTION

The embodiments of the present disclosure generally relate to information retrieval in computing systems in general and in particular to retrieving articles from various publishers corresponding to the breaking news headline.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Breaking News Articles suggestion is one of the important applications on news aggregator applications. There are methods proposed in the literature using tokens matching and lexical text-based similarity between headline and the news articles. However, lexical text-based similarity methods are not sufficient to provide desired quality results to show on consumer facing applications.

Some systems can retrieve documents based only on lexical match, mention of token in headline of breaking news and headline of items list. This will miss a lot of articles where the news is written in different words. Also, the method is not applicable for the retrieval of cross-lingual articles e.g. Hindi articles for English headlines. Other systems mainly focus on NER which is a commonly used (open source) process. Although another system deals with Breaking News, it only analyzes things like if the news article contains ads, multimedia, reputation of publisher, user interest in story (measured by views/likes) to make a comparison. No semantic/lexical/image analysis is done.

Therefore, there is a need for a system and a more accurate method of providing the relevant articles in a breaking news system that adds value in terms of more customer engagement and satisfaction.

### OBJECTS OF THE PRESENT DISCLOSURE

Some of the objects of the present disclosure, which at least one embodiment herein satisfies are as listed herein below.

It is an object of the present disclosure to retrieve the best matching news stories matching with a given headline.

It is an object of the present disclosure to provide an approach that improves the quality of coverage around a breaking news event by providing all associated news coming from other sources will increase user engagement.

It is an object of the present disclosure to provide an approach that minimizes the user effort required in exploring other aspects of the story and brings all related information to one place.

It is an object of the present disclosure to provide multi-lingual recommendations for coverage on each story in multiple languages which provides users the option to explore more news sources/publishers for each breaking news story.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides for a system for providing a breaking news headline across a plurality of domains. The system may include one or more processors operatively coupled to a plurality of first computing devices, the one or more processors coupled with a memory that may store instructions which when executed by the one or more processors may cause the system to: receive one or more first content items from the plurality of first computing devices, the one or more first content items pertaining to a plurality of news headlines received in a plurality of languages, and the one or more first content items are in any or a combination of an audio, an image, a video and a textual form. The system may further be configure to receive one or more second content items from the plurality of first computing devices, the one or more second content items pertaining to a plurality of stories received in a plurality of languages and associated with the one or more news headlines, and the one or more second content items are in any or a combination of an audio, an image, a video and a textual form. The system may be configured to extract a first set of attributes from the one or more first content items, the first set of attributes pertaining to one or more breaking news headlines and further extract a second set of attributes from the one or more second content items, the second set of attributes pertaining to any or a combination of one or more breaking news stories. Based on the extracted first set of attributes, the system may determine, by using a machine learning (ML) engine associated with the one or more processors, a similarity score between the one or more first content items and the one or more breaking news headlines. The system may then assign the similarity score to each of the one or more first content items according to the similarity present with the one or more first content items and the one or more breaking news headlines and further generate a recommendation list in any ascending or descending order of the similarity score. The recommendation list may include an ordered list of the one or more first content items based on the ascending or descending order of the similarity score associated with the one or more first content items.

In an embodiment, the system may be further configured to map the ordered list of the one or more first content items present in the recommendation list with the one or more second content items based on a mapping of the extracted first and second set of attributes; and, provide a clickable link of the ordered list of the one or more first content items present in the recommendation list with the one or more second content items based on the mapping done.

In an embodiment, the system may be further configured to determine a best story associated with the one or more second content items based on the similarity scores associated with each of the mapped second content items with the ordered list of the one or more first content items present in the recommendation list.

In an embodiment, the system may be further configured to retrieve a plurality of new stories based on one or more cross lingually trained semantic models associated with the one or more processors.

In an embodiment, the system may be further configured to look up one or more entities, by a curated knowledge graph module associated with the machine learning (ML) engine, in any or a combination of the one or more breaking news and the plurality of new stories received; and, identify, by the curated knowledge graph module, the one or more entities mentioned in any language in any of the plurality of first computing devices.

In an embodiment, the one or more processors may be associated with a source profiling module that may receive and establish a set of trusted content providers.

In an embodiment, a user interface at one or more computing devices may be configured to display a combination of the recommended list and one or more second content items provided by the set of trusted content providers.

In an embodiment, the system may be further configured to treat one or more second content items provided by the trusted content providers as a standard data and tag, the one or more second content items with the one or more breaking news headlines, for other news stories to compare to.

In an embodiment, the system may be further configured to update the recommended list by an entity matching module associated with the one or more processors. In an embodiment, the update of the recommended list is based on a text, an audio or a video based matching occurrence of one or more entities in any or a combination of one or more breaking news headlines, incoming headlines and one or more second content items comprising new stories and re rank the recommended list based on the updated recommended list.

In an embodiment, the system may be further configured to determine, by a combiner module associated with the one or more processors, a combined reranking score for the one or more new first and second content items received.

In an embodiment, the system may be further configured to iteratively add one or more new first content items to the recommended list in real time. In an embodiment, the one or more new first content items may be extracted from a continuous incoming stream of first content items received from the plurality of first computing devices, and the one or more new first content items and respective one or more new second content items associated with the one or more new first content items may be published and distributed by the trusted content providers in real time.

In an embodiment, the system may be further configured to continuously refresh and keep, using a pruning module associated with the one or more processors, a most succinct one or more new first content items to the breaking news headline from the continuous incoming stream of first and second content items.

In an embodiment, the system may be further configured to trigger an event for refreshing one or more suggestions to a plurality of users based on the continuous incoming stream of first and second content items.

In an embodiment, the system may be further configured to find out if a content provider publishes more than one first and second content item relating to a news event, determine a new version of the first content item with additional information added in the respective second content item, discard the previous version of the first content item from the recommended list; and, refresh the recommended list to include the new version of the first content item.

In an aspect, the present disclosure provides for a user equipment for providing a breaking news headline across a plurality of domains. The UE may include a processor and a receiver operatively coupled to a plurality of first computing devices, the processor coupled with a memory that stores instructions which when executed by the processor may cause the UE to receive, by the receiver, one or more first content items from the plurality of first computing devices, the one or more first content items pertaining to a plurality of news headlines received in a plurality of languages, and the one or more first content items may be in any or a combination of an audio, an image, a video and a textual form. The UE may further be configured to receive one or more second content items from the plurality of first computing devices, the one or more second content items pertaining to a plurality of stories received in a plurality of languages and associated with the one or more news headlines, and the one or more second content items are in any or a combination of an audio, an image, a video and a textual form. The UE may be configured to extract a first set of attributes from the one or more first content items, the first set of attributes pertaining to one or more breaking news headlines and further extract a second set of attributes from the one or more second content items, the second set of attributes pertaining to any or a combination of one or more breaking news stories. Based on the extracted first set of attributes, the UE may determine, by using a machine learning (ML) engine associated with the one or more processors, a similarity score between the one or more first content items and the one or more breaking news headlines. The UE may then assign the similarity score to each of the one or more first content items according to the similarity present with the one or more first content items and the one or more breaking news headlines and further generate a recommendation list in any ascending or descending order of the similarity score. The recommendation list may include an ordered list of the one or more first content items based on the ascending or descending order of the similarity score associated with the one or more first content items.

In an aspect, the present disclosure provides for a method for providing a breaking news headline across a plurality of domains. The method may include the step of receiving, by one or more processors, one or more first content items from the plurality of first computing devices, the one or more first content items pertaining to a plurality of news headlines received in a plurality of languages, and the one or more first content items may be in any or a combination of an audio, an image, a video and a textual form. In an embodiment, the one or more processors may be operatively coupled to the plurality of first computing devices, the one or more processors may be coupled with a memory that may store instructions executed by the one or more processors. The method may further include the step of receiving, by the one or more processors, one or more second content items from the plurality of first computing devices, the one or more second content items pertaining to a plurality of stories received in a plurality of languages and associated with the one or more news headlines. In an embodiment, the one or more second content items may be in any or a combination of an audio, an image, a video and a textual form, extracting, by the one or more processors (202), a first set of attributes from the one or more first content items, the first set of attributes pertaining to one or more breaking news headlines. The method may further include the step of extracting, by the one or more processors, a second set of attributes from the one or more second content items, the second set of attributes pertaining to any or a combination of one or more breaking news stories. Based on the extracted first set of attributes, the method may further include the step of determining, by using a machine learning (ML) engine, a similarity score between the one or more first content items and the one or more breaking news headlines. The method may further include the step of assigning, by the ML engine, the similarity score to each of the one or more first content items according to the similarity present with the one or more first content items and the one or more breaking news headlines, and the method may further include the step of generating, by the ML engine, a recommendation list in any ascending or descending order of the similarity score. In an embodiment, the recommendation list may include an ordered list of the one or more first content items based on the ascending or descending order of the similarity score associated with the one or more first content items.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture (100) in which or with which the system of the present disclosure can be implemented, in accordance with an embodiment of the present disclosure.

FIG. 2A illustrates an exemplary representation (200) of system (110), in accordance with an embodiment of the present disclosure.

FIG. 2B illustrates an exemplary representation (250) of a user equipment (UE) (108), in accordance with an embodiment of the present disclosure.

FIG. 3 illustrates an exemplary block diagram (300) depicting the proposed system, in accordance with an embodiment of the present disclosure.

FIG. 4 illustrates an exemplary block diagram representation (400) of the multimodal reranking module (400), in accordance with an embodiment of the present disclosure.

FIG. 5 illustrates an exemplary block diagram representation (500) of the entity matching module (500), in accordance with an embodiment of the present disclosure.

FIGS. 6A and 6B illustrate exemplary flow diagram representation of the description of finding common people, in accordance with an embodiment of the present disclosure.

FIGS. 7A and 7B illustrate exemplary block diagram representation of the event-based refreshing of recommendations, in accordance with an embodiment of the present disclosure.

FIG. 8 illustrates an exemplary computer system in which or with which embodiments of the present invention can be utilized in accordance with embodiments of the present disclosure.

The foregoing shall be more apparent from the following more detailed description of the invention.

### BRIEF DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The present disclosure relates to information retrieval in computing systems in general and in particular to retrieving articles from various publishers corresponding to the breaking news headline. The present invention provides solution to the above-mentioned problem in the art by providing a system and a method for efficiently presenting a more accurate method of providing the relevant articles in a breaking news system to add value in terms of more user engagement and satisfaction. The system can use semantic models and multilingually trained sentence transformers to generate context-based recommendations for a breaking news headline. It is further refined by use of Knowledge Graphs (KG) and additional modes of information like images, videos present in the news article. These language agnostic signals along with the semantic understanding enables to generate succinct cross lingual recommendations.

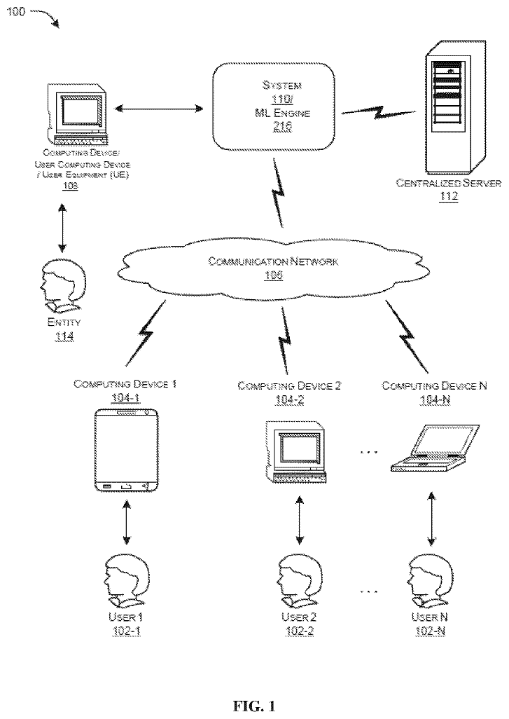

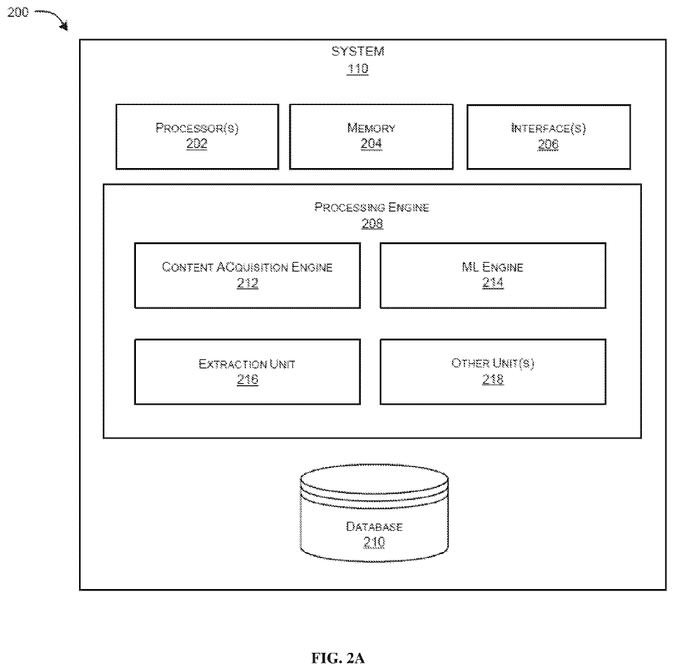

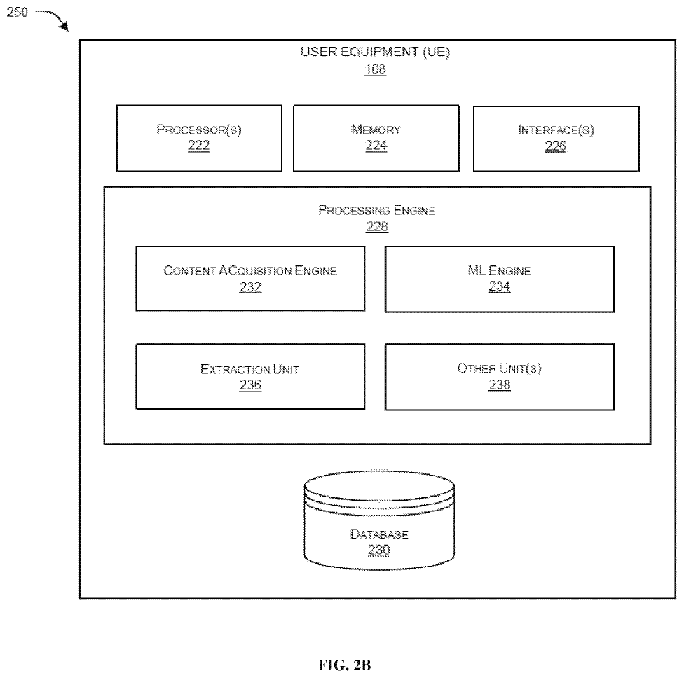

Referring to FIG. 1 that illustrates an exemplary network architecture (100) in which or with which system (110) of the present disclosure can be implemented, in accordance with an embodiment of the present disclosure. As illustrated, the exemplary architecture (100) includes a system (110) equipped with a machine learning (ML) engine (214) (Ref. FIG. 2A) for providing a breaking news headline across a plurality of domains containing distinct types of contents associated with one or more news headlines. One or more contents may be received from one or more computing devices (104-1, 104-2, . . . 104-n) (hereinafter interchangeably referred as a smart computing device; and collectively referred to as 104). The users (102) may interact with the system (110) by using their respective computing device (104), wherein the computing device (104) and the system (102) may communicate with each other over a network (106). The users (102) can include content providers, news readers, news reporters and the like.

The system (110) may be associated with a centralized server (112). Examples of the computing devices (104) can include, but are not limited to, a computing device (104) associated with media entities and entertainment-based assets, education sector, a smart phone, a portable computer, a personal digital assistant, a handheld phone and the like.

The system (110) may be further operatively coupled to a second computing device (108) (also referred to as the user computing device or user equipment (UE) hereinafter) associated with an entity (114). The entity (114) may include a company, an organisation, a university, a lab facility, a business enterprise, a defence facility, or any other secured facility. In some implementations, the system (110) may also be associated with the UE (108). The UE (108) can include a handheld device, a smart phone, a laptop, a palm top and the like. Further, the system (110) may also be communicatively coupled to the one or more first computing devices (104) via a communication network (106).

Further, the network (106) can be a wireless network, a wired network, a cloud or a combination thereof that can be implemented as one of the different types of networks, such as Intranet, BLUETOOTH, MQTT Broker cloud, Local Area Network (LAN), Wide Area Network (WAN), Internet, and the like. Further, the network 106 can either be a dedicated network or a shared network. The shared network can represent an association of the different types of networks that can use variety of protocols, for example, Hypertext Transfer Protocol (HTTP), Transmission Control Protocol/Internet Protocol (TCP/IP), Wireless Application Protocol (WAP), and the like. In an exemplary embodiment, the network 104 can be an HC-05 Bluetooth module which is an easy to use Bluetooth SPP (Serial Port Protocol) module, designed for transparent wireless serial connection setup

According to various embodiments of the present disclosure, the system (100) can provide for a machine learning (ML) based recommendation generation by using knowledge graph, particularly for providing input services. In an illustrative embodiment, the ML based techniques can include, but not limited to, a graph traversal and embeddings-based algorithms such as common nodes-based algorithms, graph convolutional methods and the like. The technique and other data model involved in the use of the technique can be accessed from a database in the server.

In an aspect, the system (110) can receive one or more first content items from the plurality of first computing devices (104). The one or more first content items may pertain to a plurality of news headlines received in a plurality of languages and the one or more first content items may be in any or a combination of an audio, an image, a video and a textual form. The system (110) may further receive one or more second content items from the plurality of first computing devices (104), the one or more second content items pertaining to a plurality of stories received in a plurality of languages and associated with the one or more news headlines. The one or more second content items may also be in any or a combination of an audio, an image, a video and a textual form. The system (110) may be further configured to extract a first set of attributes from the one or more first content items, the first set of attributes pertaining to one or more breaking news headlines and further extract a second set of attributes from the one or more second content items, the second set of attributes pertaining to any or a combination of one or more breaking news stories Based on the extracted first set of attributes, the system (110) may be configured to determine, by using a machine learning (ML) engine (214) (ref FIG. 2A), a similarity score between the one or more first content items and the one or more breaking news headlines, assign the similarity score to each of the one or more first content items according to the similarity present with the one or more first content items and the one or more breaking news headlines. The system (110) may further generate a recommendation list in any ascending or descending order of the similarity score. The recommendation list may include an ordered list of the one or more first content items based on the ascending or descending order of the similarity score associated with the one or more first content items.

In an embodiment, the system (110) may be further configured to map the ordered list of the one or more first content items present in the recommendation list with the one or more second content items based on a mapping of the extracted first and second set of attributes and provide a clickable link of the ordered list of the one or more first content items present in the recommendation list with the one or more second content items based on the mapping done.

In an exemplary embodiment, the system (110) may be further configured to determine a best story associated with the one or more second content items based on the similarity scores associated with each of the mapped second content items with the ordered list of the one or more first content items present in the recommendation list.

In yet another exemplary embodiment, the system may be further configured to retrieve a plurality of new stories based on one or more cross lingually trained semantic models associated with the one or more processors (202).

In an exemplary embodiment, a curated knowledge graph may be used by the ML engine (214) for entity lookup in the breaking news stories and new stories having both headline and body and identify entities mentioned in different surface forms or different languages.

In an exemplary embodiment, the system (110) may include a source profiling module that can establish a set of trusted content providers. From the most similar news stories returned by the semantic module, the image and video in the news published by the trusted content provider be treated as the standard data and be tagged with the breaking news headline, for other news stories to compare to.

In an exemplary embodiment, the system (110) may enable reranking of recommended stories by an entity matching module which does text based matching of occurrence of entities in breaking news headline and incoming news stories' headline and content. Additionally, the system (110) may enable reranking based on image attributes by choosing an image of the content that is most similar according to text-based models as an anchor image and generate an anchor-recommended image pair. For the anchor and the recommended images, the system (110) may then find out if there are common users occurring in all anchor-recommended image pairs. The system (110) may be configured to compute visual similarity between all anchor-recommended image pairs.

In an exemplary embodiment, the system (110) may further include a combiner module to provide for a combined reranking score from all text and media items. The system (110) may be configured to iteratively add more similar news stories to the recommended list in real time, with an incoming stream of content being published by the trusted content providers, distributed in time.

In an exemplary embodiment, a pruning module associated with the ML engine (214) may be configured to continuously refresh and keep the most succinct similar new stories associated with the breaking news headline from a continuous incoming stream of content items.

Alternatively, if a content provider publishes more than one content relating to the same news event, the system (110) can determine a version with additional information added, and can discard the previous version from recommended list. The recommended list may be now refreshed which now comprises of an old set and new similar news stories added from live feed. The system (110) can trigger an event for refreshing suggestions to users.

FIG. 2A illustrates an exemplary representation (200) of system (110), in accordance with an embodiment of the present disclosure.

In an aspect, the system (110) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) 206. The interface(s) 206 may comprise a variety of interfaces, for example, interfaces for data input and output devices, referred to as I/O devices, storage devices, and the like. The interface(s) 206 may facilitate communication of the system (110). The interface(s) 206 may also provide a communication pathway for one or more components of the centralized server (112). Examples of such components include, but are not limited to, processing engine(s) 208 and a database (210).

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

The processing engine (208) may include one or more engines selected from any of a content acquisition engine (210), an ML engine (214), an extraction engine (216) and other units (218). The other units (218) may include one of a source profiling module, a semantic module, entity matching module, combiner module, pruning module trigger generating module and the like.

FIG. 2B illustrates an exemplary representation (250) of the user equipment (UE) (108), in accordance with an embodiment of the present disclosure. In an aspect, the UE (108) may comprise a processor (222). The more processor (222) may be implemented as one or more microprocessors, microcomputers, microcontrollers, digital signal processors, central processing units, logic circuitries, and/or any devices that process data based on operational instructions. Among other capabilities, the processor(s) (222) may be configured to fetch and execute computer-readable instructions stored in a memory (224) of the UE (108). The memory (224) may be configured to store one or more computer-readable instructions or routines in a non-transitory computer readable storage medium, which may be fetched and executed to create or share data packets over a network service. The memory (224) may comprise any non-transitory storage device including, for example, volatile memory such as RAM, or non-volatile memory such as EPROM, flash memory, and the like.

In an embodiment, the UE (108) may include an interface(s) 206. The interface(s) 206 may comprise a variety of interfaces, for example, interfaces for data input and output devices, referred to as I/O devices, storage devices, and the like. The interface(s) 206 may facilitate communication of the UE (108). Examples of such components include, but are not limited to, processing engine(s) 228 and a database (230).

The processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the UE (108) may comprise the machine-readable storage medium storing the instructions and the processing resource to execute the instructions, or the machine-readable storage medium may be separate but accessible to the UE (108) and the processing resource. In other examples, the processing engine(s) (228) may be implemented by electronic circuitry.

The processing engine (228) may include one or more engines selected from any of a content acquisition engine (230), an ML engine (234), an extraction engine (236) and other units (238). The other units (238) may include one of a source profiling module, a semantic module, entity matching module, combiner module, pruning module trigger generating module and the like.

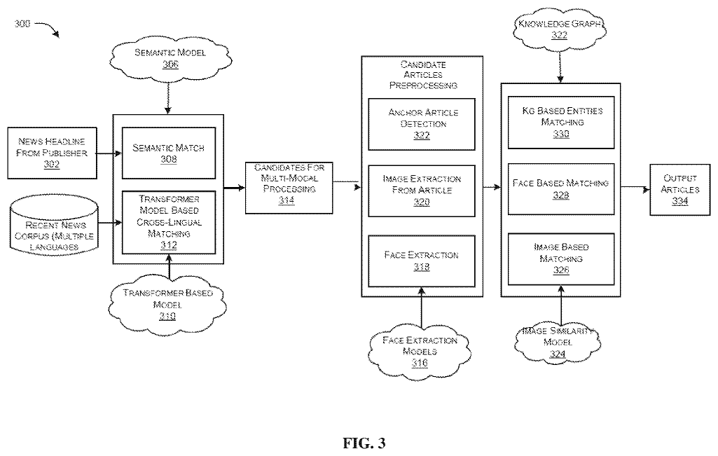

FIG. 3 illustrates an exemplary block diagram (300) depicting the proposed system, in accordance with an embodiment of the present disclosure. In an aspect, the block diagram (300) may include news headline from publisher (302) and recent news corpus (304) that can be sent to semantically match (308) context of breaking news headline and news articles with the help of a semantic model (306).

In an exemplary embodiment, the semantic matching retrieves more results compared to lexical matching of token. Same story could be written in different ways by journalists from different publishing houses. The semantic models capture the topic distribution in articles and relates the different styles of writing together. Additionally, context aware multilingually trained sentence transformers help in retrieving relevant articles across languages with Breaking news headline provided in just one language.

In an exemplary embodiment, the system (110) can extract entities from headline and news articles (314). Tokens from headlines and news articles may be then passed into this module to get entities associated with the headline and news contents or articles (322, 320). Entity extraction is done with the help of knowledge graph (332). This is to ensure even if entities are written in different forms and different languages, the matching of the entities can be done (330).

In an exemplary embodiment, the entity matching can also done with the help of knowledge graph. Multiple entities can be retrieved with the same token. For example, ‘Apple’ may retrieve Apple as a fruit and company. The Knowledge graph (330) helps in associating appropriate entities with tokens.

In an exemplary embodiment, the extraction module may also extract an image from the content or the article (320) and associate the image with the breaking news headline to be compared against recommended articles' images.

In an exemplary embodiment, the extraction module may further retrieve images or videos from one or more recommended articles and use in improving accuracy of the match. The system may then generate a list of the recommended items by combining the results from above methods.

In an exemplary embodiment, an event triggering module generates a trigger to update the similar articles on the basis of live feed. The system may further add and keep the latest articles with additive information about the event and prune previous version of the same event.

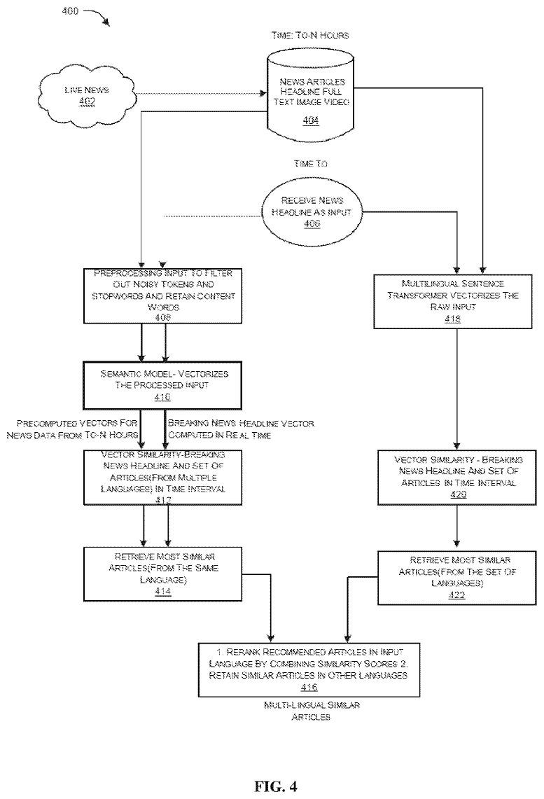

FIG. 4 illustrates an exemplary block diagram representation (400) of the multimodal reranking module (400), in accordance with an embodiment of the present disclosure. As illustrated, the multimodal reranking module (400) may be configured to retrieve the relevant news articles (402) belonging to multiple news providers (404) relevant to a news headline. The news headline is sent by one of the providers or external third party (406). The content input is sent to a pre-processing filter to filter out noisy tokens and stopwords and retain content words (408) or to the content input can be sent to a multilingual sentence transformer to vectorize raw input to check for vector similarity (420) and then retrieve most similar articles (422) from the various set of languages. On the other hand, a semantic model (410) vectorizes the processed input from the preprocessing filter and provide precomputed vectors for news data from TO-N and the breaking news headline computed in real time to the vector similarity checking module (414) and retrieve the most similar article from the same language. A reranking module (416) then receives the most similar articles from (414) and (422) and reranks recommended articles in the input language by comparing similarity scores and further retains similar articles in different languages.

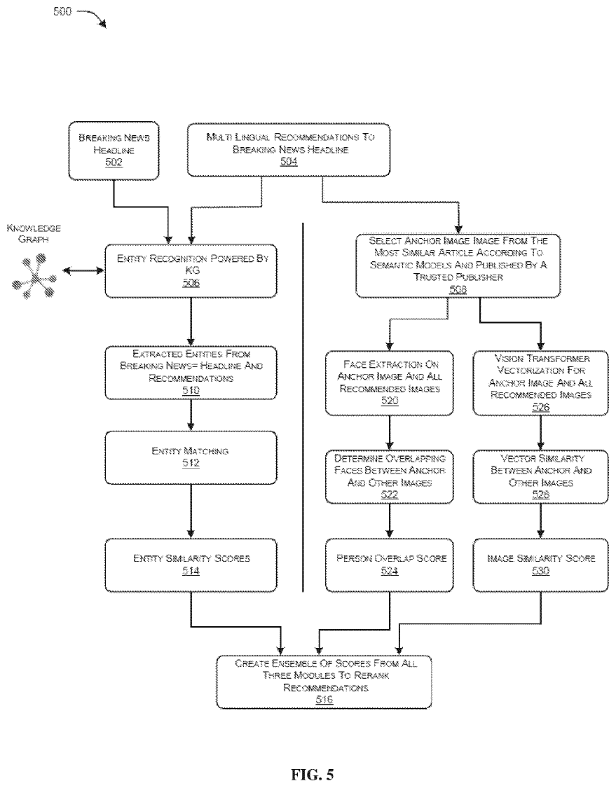

FIG. 5 illustrates an exemplary block diagram representation (500) of the entity matching module (500), in accordance with an embodiment of the present disclosure. As illustrated, in an aspect, a curated knowledge graph (332) that has a plethora of entities (502), their relationship with other entities, their attributes, names in all Indian languages and an entity id.

The entity matching modules (512) does text segmentation and tokenization on breaking news headline and headline (502) and full text of articles from recommended list (504). It does entity lookup of these tokens in Knowledge Graph (332) and assigns an id. It can recognize entity names in all languages, in all surface forms and relate it with the same id. An entity matching algorithm compares the entities between the breaking news headline and recommended articles and assigns a similarity score (514) to each article basis of that and then does the reranking of the articles (516). From the list of articles returned by semantic text similarity models, the most similar ones are filtered. If they are published by one of the credible sources, the image corresponding to the most similar article is taken as the anchor image (508). For anchor image and images from all recommended articles, pass them through an image transformer network (526). This helps convert them into vectors which enables us to capture similarity based on image content and style (528) and then Compute vector similarity between all pairs of anchor-recommended image (530). Additionally, face extraction can be done from the anchor image (520) and then overlapped faces are determined (522) from which a person overlapped score is generated (524). Finally, all the scores from (514), (524) and (530) are obtained to rerank recommendations (516).

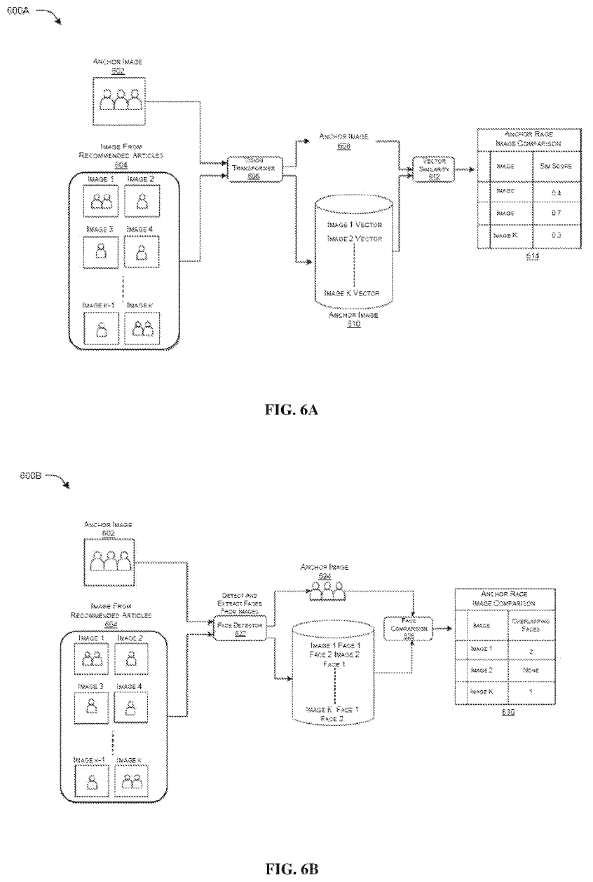

FIGS. 6A and 6B illustrate exemplary flow diagram representation of the description of finding common people, in accordance with an embodiment of the present disclosure. As illustrated in FIG. 6A, for anchor image (602) and images from all recommended articles (604). A vision transformer (606) may detect images and extract all images and compare with the anchor image through the vector similarity module (612) and re rank and store all the images according to the similarity score obtained (614).

FIG. 6B illustrates that faces from all other images detected by a face detector (622) of recommended articles may determine if any face also occurs in the anchor image (602) by comparing the face images (626) with the anchor faces (624). This returns a face overlap score between all pairs of anchor-recommended image (630).

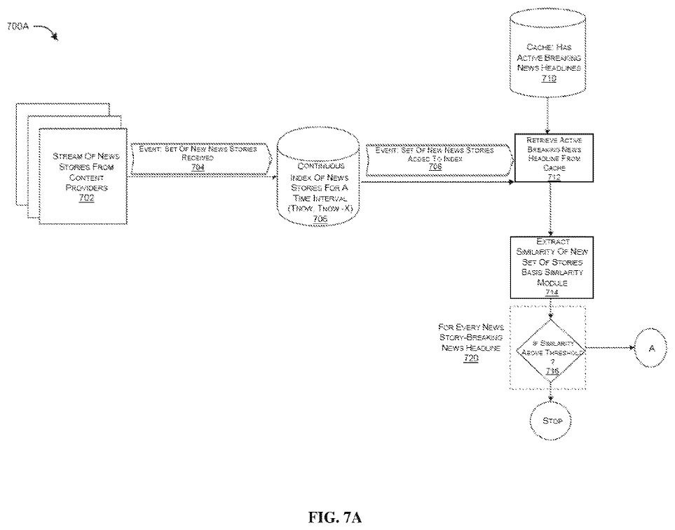

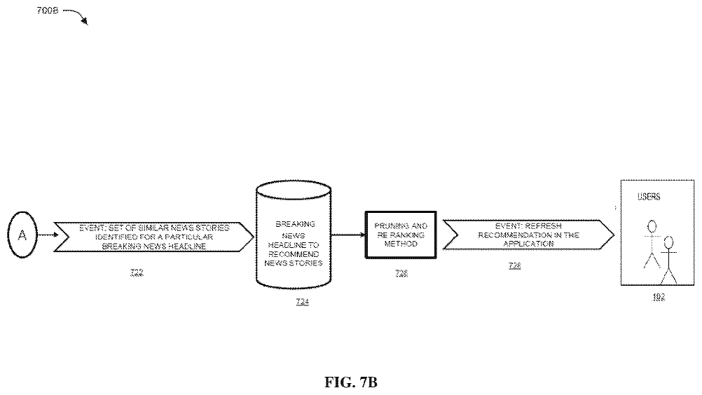

FIGS. 7A and 7B illustrate exemplary block diagram representation of the event based refreshing of recommendations, in accordance with an embodiment of the present disclosure. As illustrated, stream of news stories from content providers (702) may be received to create an event (704) for a continuous index of news stories for a time interval (706) and a stream of new news stories are added to it (708). Meanwhile a cache stores all active breaking news headline (710) that can be provided to retrieve active breaking news headline from cache (712) and then extract similarity of new set of stories based on similarity module (714). For every news breaking headline (720) if similarity score is not above threshold, then the process terminates, else as illustrated in FIG. 7B an event is created by identifying a set of new similar news stories for a particular breaking news headline (722) and stored in a database having breaking news headline to recommended news stories (724). The recommended stories are then pruned and re re ranked (726) and then the application is refreshed (728) by the users (102).

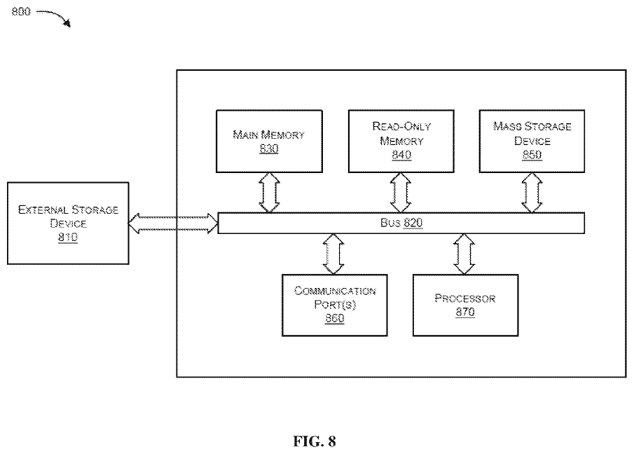

FIG. 8 illustrates an exemplary computer system in which or with which embodiments of the present invention can be utilized in accordance with embodiments of the present disclosure. As shown in FIG. 8, computer system 800 can include an external storage device 810, a bus 820, a main memory 830, a read only memory 840, a mass storage device 850, communication port 860, and a processor 870. A person skilled in the art will appreciate that the computer system may include more than one processor and communication ports. Processor 870 may include various modules associated with embodiments of the present invention. Communication port 860 may be chosen depending on a network, or any network to which computer system connects. Memory 830 can be Random Access Memory (RAM), or any other dynamic storage device commonly known in the art. Mass storage 850 may be any current or future mass storage solution, which can be used to store information and/or instructions.

Bus 820 communicatively couples processor(s) 870 with the other memory, storage and communication blocks.

Optionally, operator and administrative interfaces, e.g, a display, keyboard, joystick and a cursor control device, may also be coupled to bus 820 to support direct operator interaction with a computer system. Other operator and administrative interfaces can be provided through network connections connected through communication port 860. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### Advantages of the Present Disclosure

The present disclosure provides a system and a method to retrieve the best matching news stories matching with a given headline.

The present disclosure provides an approach that improves the quality of coverage around a breaking news event by providing all associated news coming from other sources will increase user engagement.

The present disclosure provides an approach that minimizes the user effort required in exploring other aspects of the story and brings all related information to one place.

The present disclosure provides multi-lingual recommendations for coverage on each story in multiple languages which provides users the option to explore more news sources/publishers for each breaking news story.

We claim:

1. A system (110) for providing a breaking news headline across a plurality of domains, said system (110) comprising;
one or more processors (202) operatively coupled to a plurality of first computing devices (104), the one or more processors (202) coupled with a memory (204), wherein said memory (204) stores instructions which when executed by the one or more processors (202) causes said system (110) to:
receive one or more first content items from the plurality of first computing devices (104), the one or more first content items pertaining to a plurality of news headlines received in a plurality of languages, wherein the one or more first content items are in any or a combination of an audio, an image, a video and a textual form;
receive one or more second content items from the plurality of first computing devices (104), the one or more second content items pertaining to a plurality of stories received in a plurality of languages and associated with the one or more news headlines, wherein the one or more second content items are in any or a combination of an audio, an image, a video and a textual form;
extract a first set of attributes from the one or more first content items, the first set of attributes pertaining to one or more breaking news headlines;
extract a second set of attributes from the one or more second content items, the second set of attributes pertaining to any or a combination of one or more breaking news stories;
based on the extracted first set of attributes, determine, by using a machine learning (ML) engine (214), a similarity score between the one or more first content items and the one or more breaking news headlines, wherein the ML engine is associated with the one or more processors (202);
assign the similarity score to each of the one or more first content items according to the similarity present with the one or more first content items and the one or more breaking news headlines; and
generate a recommendation list in any ascending or descending order of the similarity score, wherein the recommendation list comprises an ordered list of the one or more first content items based on the ascending or descending order of the similarity score associated with the one or more first content items.

2. The system as claimed in claim 1, wherein the system is further configured to:
map the ordered list of the one or more first content items present in the recommendation list with the one or more second content items based on a mapping of the extracted first and second set of attributes; and,
provide a clickable link of the ordered list of the one or more first content items present in the recommendation list with the one or more second content items based on the mapping done.

3. The system as claimed in claim 1, wherein the system is further configured to:
determine a best story associated with the one or more second content items based on the similarity scores associated with each of the mapped second content items with the ordered list of the one or more first content items present in the recommendation list.

4. The system as claimed in claim 1, wherein the system is further configured to retrieve a plurality of new stories based on one or more cross lingually trained semantic models associated with the one or more processors (202).

5. The system as claimed in claim 1, wherein the system is further configured to look up one or more entities, by a curated knowledge graph module associated with the machine learning (ML) engine, in any or a combination of the one or more breaking news and the plurality of new stories received; and,
identify, by the curated knowledge graph module, the one or more entities mentioned in any language in any of the plurality of first computing devices.

6. The system (110) as claimed in claim 1, wherein the one or more processors are associated with a source profiling module, wherein the source profiling module receives and establishes a set of trusted content providers.

7. The system as claimed in claim 6, wherein a user interface at one or more computing devices (104) is configured to display a combination of the recommended list and one or more second content items provided by the set of trusted content providers.

8. The system (110) as claimed in claim 6, the system is configured to
treat one or more second content items provided by the trusted content providers as a standard data;
tag, the one or more second content items with the one or more breaking news headlines, for other news stories to compare to.

9. The system (110) as claimed in claim 1, wherein the system is further configured to:
update the recommended list by an entity matching module associated with the one or more processors, wherein the update of the recommended list is based on a text, an audio or a video based matching occurrence of one or more entities in any or a combination of one or more breaking news headlines, incoming headlines and one or more second content items comprising new stories;
re rank the recommended list based on the updated recommended list.

10. The system (110) as claimed in claim 1, wherein the system is further configured to:
determine, by a combiner module associated with the one or more processors (202), a combined reranking score for the one or more new first and second content items received.

11. The system (110) as claimed in claim 1, wherein the system is further configured to:
iteratively add one or more new first content items to the recommended list in real time, wherein the one or more new first content items are extracted from a continuous incoming stream of first content items received from the plurality of first computing devices, and wherein the one or more new first content items and respective one or more new second content items associated with the one or more new first content items are published and distributed by the trusted content providers in real time.

12. The system (110) as claimed in claim 1, wherein the system is further configured to:
continuously refresh and keep, using a pruning module associated with the one or more processors (202), the most succinct one or more new first content items to the breaking news headline from the continuous incoming stream of first and second content items.

13. The system (110) as claimed in claim 11, wherein the system is configured to
trigger an event for refreshing one or more suggestions to a plurality of users based on the continuous incoming stream of first and second content items.

14. The system (110) as claimed in claim 1, wherein the system is further configured to:
find out if a content provider publishes more than one first and second content item relating to a news event;
determine a new version of the first content item with additional information added in the respective second content item;
discard the previous version of the first content item from the recommended list; and,
refresh the recommended list to include the new version of the first content item.

15. A user equipment (108) for providing a breaking news headline across a plurality of domains, said UE (108) comprising;
a processor and a receiver, wherein the processor (222) operatively coupled to a plurality of first computing devices (104), the processor (222) coupled with a memory (224), wherein said memory (224) stores instructions which when executed by the one or more processors (222) causes said system (110) to:
receive, by the receiver, one or more first content items from the plurality of first computing devices (104), the one or more first content items pertaining to a plurality of news headlines received in a plurality of languages, wherein the one or more first content items are in any or a combination of an audio, an image, a video and a textual form;
receive, by the receiver, one or more second content items from the plurality of first computing devices (104), the one or more second content items pertaining to a plurality of stories received in a plurality of languages and associated with the one or more news headlines, wherein the one or more second content items are in any or a combination of an audio, an image, a video and a textual form;
extract, by the processor, a first set of attributes from the one or more first content items, the first set of attributes pertaining to one or more breaking news headlines;
extract, by the processor, a second set of attributes from the one or more second content items, the second set of attributes pertaining to any or a combination of one or more breaking news stories;
based on the extracted first set of attributes, determine, by using a machine learning (ML) engine (214), a similarity score between the one or more first content items and the one or more breaking news headlines, wherein the ML engine is associated with the processors (222);
assign, by the processor, the similarity score to each of the one or more first content items according to the similarity present with the one or more first content items and the one or more breaking news headlines; and
generate, by the processor, a recommendation list in any ascending or descending order of the similarity score, wherein the recommendation list comprises an ordered list of the one or more first content items based on the ascending or descending order of the
similarity score associated with the one or more first content items.

16. The UE (108) as claimed in claim 15, wherein the processor is associated with a source profiling module, wherein the source profiling module receives and establishes a set of trusted content providers.

17. The UE (108) as claimed in claim 16, wherein a user interface equipped in the UE is configured to display a combination of the recommended list and one or more second content items provided by the set of trusted content providers.

18. A method for providing a breaking news headline across a plurality of domains, said method comprising;
receiving, by one or more processors (202), one or more first content items from the plurality of first computing devices (104), the one or more first content items pertaining to a plurality of news headlines received in a plurality of languages, wherein the one or more first content items are in any or a combination of an audio, an image, a video and a textual form, wherein the one or more processors (202) are operatively coupled to the plurality of first computing devices (104), the one or more processors (202) coupled with a memory (204) that stores instructions executed by the one or more processors (202);
receiving, by the one or more processors (202), one or more second content items from the plurality of first computing devices (104), the one or more second content items pertaining to a plurality of stories received in a plurality of languages and associated with the one or more news headlines, wherein the one or more second content items are in any or a combination of an audio, an image, a video and a textual form;
extracting, by the one or more processors (202), a first set of attributes from the one or more first content items, the first set of attributes pertaining to one or more breaking news headlines;
extracting, by the one or more processors (202), a second set of attributes from the one or more second content items, the second set of attributes pertaining to any or a combination of one or more breaking news stories;
based on the extracted first set of attributes, determining, by using a machine learning (ML) engine (214), a similarity score between the one or more first content items and the one or more breaking news headlines, wherein the ML engine is associated with the one or more processors (202);
assigning, by the ML engine (214), the similarity score to each of the one or more first content items according to the similarity present with the one or more first content items and the one or more breaking news headlines; and
generating, by the ML engine (214), a recommendation list in any ascending or descending order of the similarity score, wherein the recommendation list comprises an ordered list of the one or more first content items based on the ascending or descending order of the similarity score associated with the one or more first content items.

19. The method as claimed in claim 18, wherein the method further comprises the step of:
mapping, by the ML engine (214), the ordered list of the one or more first content items present in the recommendation list with the one or more second content items based on a mapping of the extracted first and second set of attributes; and,
provide, by the ML engine (214), a clickable link of the ordered list of the one or more first content items present in the recommendation list with the one or more second content items based on the mapping done;
determining, by the ML engine (214), a best story associated with the one or more second content items based on the similarity scores associated with each of the mapped second content items with the ordered list of the one or more first content items present in the recommendation list.

20. The method as claimed in claim 18, wherein the method further comprises the step of:
Looking up one or more entities, by a curated knowledge graph module associated with the machine learning (ML) engine, in any or a combination of the one or more breaking news and the plurality of new stories received; and,
identifying, by the curated knowledge graph module, the one or more entities mentioned in any language in any of the plurality of first computing devices.

21. The method as claimed in claim 18, wherein the method further comprises the step of:
Updating, by the ML engine (214), the recommended list by an entity matching module associated with the one or more processors, wherein the update of the recommended list is based on a text, an audio or a video based matching occurrence of one or more entities in any or a combination of one or more breaking news headlines, incoming headlines and one or more second content items comprising new stories;
Re-ranking, by the ML engine (214), the recommended list based on the updated recommended list.

22. The method as claimed in claim 18, wherein the method further comprises the step of:
iteratively adding one or more new first content items to the recommended list in real time, wherein the one or more new first content items are extracted from a continuous incoming stream of first content items received from the plurality of first computing devices, and wherein the one or more new first content items and respective one or more new second content items associated with the one or more new first content items are published and distributed by the trusted content providers in real time;
continuously refreshing and keeping, using a pruning module associated with the one or more processors (202), a most succinct one or more new first content items to the breaking news headline from the continuous incoming stream of first and second content items; triggering an event for refreshing one or more suggestions to a plurality of users based on the continuous incoming stream of first and second content items.

23. The method as claimed in claim 18, wherein the method further comprises the step of:
finding out if a content provider publishes more than one first and second content item relating to a news event;
determining a new version of the first content item with additional information added in the respective second content item;
discarding the previous version of the first content item from the recommended list; and,
refreshing the recommended list to include the new version of the first content item.
